(19) United States
(12) Patent Application Publication
(10) Pub. No.: US 2010/0073978 A1
(43) Pub. Date: Mar. 25, 2010

(54) BRIDGE RECTIFIER CIRCUIT WITH BIPOLAR TRANSISTORS

(75) Inventors: Josef Paul Schaffer, Bruckmuehl (DE); Jakob Huber, Beyharting (DE); Hermann Seitz, Munich (DE)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/238,179

(22) Filed: Sep. 25, 2008

(51) Int. Cl. H02M 7/219

(52) U.S. Cl. 363/127

(57) ABSTRACT

A bridge rectifier circuit including a first and second pair of bipolar transistors, wherein the bipolar transistors of each pair have conductivity types that are opposite from one another; first and second input terminals coupled to each of the bipolar transistors; and first and second output terminals coupled to each of the bipolar transistors. Furthermore, each of the bipolar transistors is configured to operate in reverse-active mode.

### BACKGROUND

Bridge rectifiers are circuits capable of converting an alternating current input into a direct current. A conventional bridge rectifier generally consists of a pair of inputs to receive alternating current and a pair of outputs to supply the direct current. Moreover, conventional bridge rectifiers generally provide an arrangement of four diodes connected in a bridge circuit to serve as a full-wave rectifier. A full-wave rectifier converts the whole of the input waveform to one of constant polarity (positive or negative) at its output. Full-wave rectification converts both polarities of the input waveform to direct current, and is more efficient.

With regard to electronic circuitry components, reverse-active mode (also referred to as inverse-active or inverted) means reversing the biasing conditions of the forward-active region. For bipolar transistors operating in reverse-active mode, the emitter and collector regions switch roles. Since conventional bipolar transistors have been designed to maximize current gain in forward-active mode, the current gain in reverse-active mode is substantially smaller. As a result, this transistor mode has been seldom used, and usually is only used for failsafe conditions and certain types of bipolar logic circuits. Generally, the reverse bias breakdown voltage to the base is an order of magnitude lower in this region.

### BRIEF DESCRIPTION OF THE DRAWINGS

FIG. 1A is a detailed schematic diagram of a bridge rectifier in accordance with one exemplary embodiment.

FIG. 1B is a detailed schematic diagram of a bridge rectifier in accordance with another exemplary embodiment.

### DETAILED DESCRIPTION

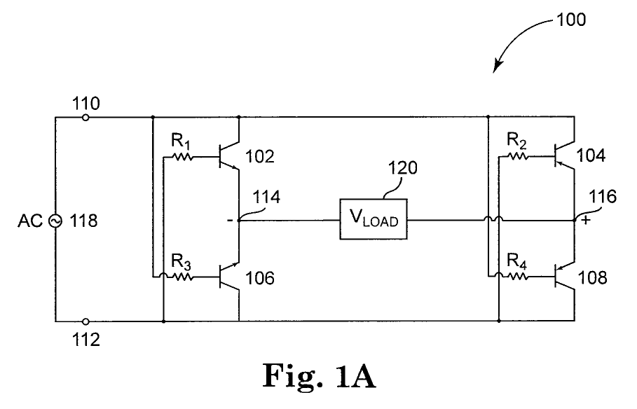

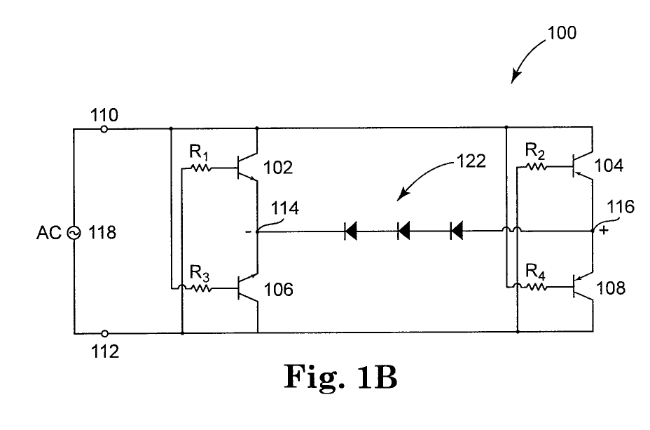

Referring to FIG. 1A, a schematic diagram of bridge rectifier 100 is shown in accordance with an exemplary embodiment of the present invention. Bridge rectifier 100 includes two pairs of bipolar transistors 102, 104 and 106, 108, which are each coupled to a pair of input terminals 110, 112 and a pair of output terminals 114, 116. In the exemplary embodiment, the input terminals 110, 112 are coupled to a voltage source 118 supplying alternating current. An electrical load 120, such as a light-emitting diode (“LED”), can be coupled between the output terminals 114, 116. Of course, it should be understood by those of ordinary skill in the art that any type of electrical load capable of functioning with a DC voltage can be coupled between the output terminals 114, 116 of bridge rectifier 100.

A bipolar transistor consists of a base, an emitter and a collector. In the exemplary embodiment, the respective collectors of bipolar transistors 102 and 104 are each coupled to input terminal 110 and the respective collectors of bipolar transistors 106 and 108 are each coupled to input terminal 112. Furthermore, the respective bases of bipolar transistors 106 and 108 are each coupled to input terminal 110 and the respective bases of bipolar transistors 102 and 104 are each coupled to input terminal 112. Finally, the emitters of bipolar transistors 102 and 106 are each coupled to the first output terminal 114, and the emitters of bipolar transistors 104 and 108 are each coupled to the second output terminal 116.

In the exemplary embodiment, the first pair of bipolar transistors 102 and 104 have conductivity types that are opposite from one another. For example, bipolar transistor 102 can be an NPN-type transistor and bipolar transistor 104 can be a PNP-type transistor. Furthermore, the second pair of bipolar transistors 106 and 108 also have conductivity types that are opposite from one another. For example, bipolar transistor 106 can be an NPN-type transistor and bipolar transistor 108 can be a PNP-type transistor. It is noted that bipolar transistors 102 and 106 should have the same type of conductivity and that bipolar transistors 104 and 108 should have the same type of conductivity. The base of an NPN transistor is a P-doped layer while the collector and emitter are N-doped layers. In the alternative, PNP transistors consist of a base that is an N-doped layer while its collector and emitter are P-doped layers. In another embodiment, bipolar transistors 102 and 106 could be PNP-type transistors and bipolar transistors 104 and 108 could be NPN-type transistors. This arrangement would still result in each pair of transistors having bipolar transistors that are of opposite conductivity from one another.

As discussed above, in the exemplary embodiment, input terminals 110 and 112 are coupled to an AC voltage source 118. Moreover, each of the bipolar transistors 102, 104, 106, 108 is configured to operate in reverse-active mode. Bipolar transistors 102 and 106, which are NPN-type transistors in the exemplary embodiment, are configured such that current flows into the emitter towards the base-emitter junctions and out of the collector away from the collector-base junctions. Moreover, bipolar transistors 104 and 108, which are PNP-type transistors in the exemplary embodiment, are configured such that current flows into the collector towards the respective collector-base junctions and out of the emitter away from the base-emitter junctions.

Accordingly, in operation, when the analog input voltage source 118 that is applied to input terminals 110 and 112 is in the first half cycle of voltage, i.e., when the voltage at input terminals 110 is more positive than the voltage at terminal 112, bipolar transistors 106 and 104 are turned to the ON state in reverse-active mode. Accordingly, current flows out of the emitter of bipolar transistor 104 through the electrical load 120, which is coupled between output terminals 116 and 114, and out of bipolar transistor 106. Subsequently, when the analog input voltage source is in the second half of the voltage cycle, current flows through bipolar transistors 102 and 108. It should be noted that as a result of the design, current is flowing from the second output terminal 116 to the first output terminal 114 through electrical load 120.

Furthermore, in the exemplary embodiment, resistors are used to couple the respective base of each bipolar transistor to the corresponding input terminals 110, 112. For example, resistors R3 and R4 are coupled between input terminal 110 and the respective bases of each bipolar transistor of the second pair of bipolar transistors 106 and 108. Also, resistors R1 and R2 are coupled between input terminal 112 and the respective bases of each bipolar transistor of the first pair of bipolar transistors 102 and 104. It should be understood that the present invention is not limited to the use of resistors to bias the bipolar transistors; rather, any known method of applying base current may be employed. Such methods include, but are not limited to, using R-C combinations or using resistors between the base and emitter of the transistor to speed up the switching time.

Moreover, it should be further understood that Zener diodes (not shown) can be coupled to the respective bases of the transistors 102, 104, 106 and 108 to drive the bases of these transistors. Employing Zener diodes enables the circuit designer to configure the transistors to turn on at certain voltage levels as controlled by the Zener diode. Moreover, the Zener diodes will help accelerate the analog to digital conversion being performed by bridge rectifier 100.

One advantage of bridge rectifier 100 is the minimal number of components necessary to rectify the AC voltage source 118. Such efficiency can be accomplished as a result of the bipolar transistors employed in the exemplary embodiment, and more specifically, the distinguishing characteristics of these bipolar transistors. In the exemplary embodiment, bipolar transistors 102, 104, 106, 108 are designed and manufactured to maintain a high breakdown voltage in the OFF state. Moreover, the exemplary transistors are designed with a high reverse current gain (hFE). Conventional bipolar transistors operating in reverse-active mode have a low reverse hFE, for example, a reverse hFE of approximately 10. In the exemplary embodiment, bridge rectifier 100 functions most effectively having transistors with a reverse hFE closer to 100. Of course, it should be reiterated that employing transistors with a reverse hFE of 100 is an example and that the present application should not be limited to any specific reverse hFE.

Furthermore, some conventional rectifiers employ transformers to compensate for the deficiencies of conventional transistors operating in reverse-active mode. Of course transformers increase the number of components of the circuit and limit the frequency of the AC input voltage that can be rectified. The implementation of bipolar transistors with a high reverse hFE, where the transistors of each pair of bipolar transistors have opposite conductivities, avoids the need for transformers and increases the frequency range of the AC input voltage that can be rectified.

Another exemplary embodiment is shown in FIG. 1B. As shown in FIG. 1B, bridge rectifier 100 comprises substantially the same circuit components as described above with respect to FIG. 1A, and specifically, bipolar transistors 102, 104, 106 and 108 configured to operate in reverse-active mode. Moreover, in this embodiment, the load coupled between output terminals 116 and 114 comprises one or more LEDs 122. As a result, whether the analog input voltage source 118 that is applied to input terminals 110 and 112 is in the first or second half cycle of voltage, DC current is flowing between output terminals 116 and 114 and therefore through LEDs 122, which effectively emit light as a result.

It should be reiterated, as noted above, that any type of electrical load capable of functioning with a DC voltage can be coupled between the output terminals 114 and 116 of bridge rectifier 100. As such, the present invention is not limited to the electrical load comprising one or more LEDs 122 as shown in FIG. 1B.

Furthermore, it is noted that for either embodiment discussed above, transistors 102, 104, 106, 108 of bridge rectifier 100 may be packaged either individually, collectively as one package, or as two pairs of transistors. For example, NPN-type transistors 102, 106 may be mounted in one package and PNP-type transistors 104 and 108 may be mounted in a second package. Alternatively, each pair of transistors with opposite polarity may be mounted in a separate package. Thus, NPN-type transistor 102 and PNP-type transistor 104 may be mounted in one package and NPN-type transistor 106 and PNP-type transistor 108 may be mounted in a second package, such design being reasonable if the backside of the transistor is the collector. Of course, these are merely examples of manufacturing designs and are in no way intended to limit the scope of the invention.

While the foregoing has been described in conjunction with an exemplary embodiment, it is understood that the term “exemplary” is merely meant as an example, rather than the best or optimal. Accordingly, this application is intended to cover alternatives, modifications and equivalents, which may be included within the spirit and scope of the invention.

Additionally, in the preceding detailed description, numerous specific details have been set forth in order to provide a thorough understanding. However, it should be apparent to one of ordinary skill in the art that the present invention may be practiced without these specific details. In other instances, well-known methods, procedures, components, and circuits have not been described in detail so as not to unnecessarily obscure aspects of the present invention.

1. A bridge rectifier circuit comprising:
a first and second pair of bipolar transistors, wherein the bipolar transistors of each pair have conductivity types that are opposite from one another;
first and second input terminals coupled to each of the bipolar transistors; and
first and second output terminals coupled to each of the bipolar transistors,
wherein each of the bipolar transistors is configured to operate in reverse-active mode.

2. The bridge rectifier circuit of claim 1, wherein respective collectors of the first pair of bipolar transistors are coupled to the first input terminal.

3. The bridge rectifier circuit of claim 1, wherein respective bases of the first pair of bipolar transistors are coupled to the second input terminal.

4. The bridge rectifier circuit of claim 1, wherein respective emitters of the first pair of bipolar transistors are coupled to the first and second output terminals, respectively.

5. The bridge rectifier circuit of claim 1, wherein one bipolar transistor of the first pair of bipolar transistors is an NPN-type transistor and the other bipolar transistor of the first pair of bipolar transistors is a PNP-type transistor.

6. The bridge rectifier circuit of claim 1, wherein respective collectors of the second pair of bipolar transistors are coupled to the second input terminal.

7. The bridge rectifier circuit of claim 1, wherein respective bases of the second pair of bipolar transistors are coupled to the first input terminal.

8. The bridge rectifier circuit of claim 1, wherein respective emitters of the second pair of bipolar transistors are coupled to the first and second output terminals, respectively.

9. The bridge rectifier circuit of claim 3, wherein respective bases of the second pair of bipolar transistors are coupled to the first input terminal, and further comprising a resistor coupled between each of the respective bases of the bipolar transistors and the respective input terminals.

10. The bridge rectifier circuit of claim 1, wherein an analog input voltage is supplied at the input terminals.

11. The bridge rectifier circuit of claim 1, further comprising at least one light emitting diode coupled between the first and second output terminals.

12. The bridge rectifier circuit of claim 1, further comprising a Zener diode coupled between the respective base of each bipolar transistor and the respective input terminal.

13. The bridge rectifier circuit of claim 1, wherein the first pair of bipolar transistors are mounted in a first package and the second pair of bipolar transistors are mounted in a second package.

14. The bridge rectifier circuit of claim 1, wherein both pairs of bipolar transistors are mounted in one package.

15. The bridge rectifier circuit of claim 1, wherein each bipolar transistor is mounted in a separate package.

16. A bridge rectifier circuit comprising:
first and second input terminals;
first and second output terminals;
a pair of NPN-type transistors, each having the emitter coupled to the first output terminal; and
a pair of PNP-type transistors, each having the emitter coupled to the second output terminal,
wherein the NPN-type transistors and PNP-type transistors are each configured to operate in reverse-active mode.

17. The bridge rectifier circuit of claim 16, wherein a base of a first transistor of the pair of NPN-type transistors is coupled to the first input terminal, and wherein a base of a second transistor of the pair of NPN-type transistors is coupled to the second input terminal.

18. The bridge rectifier circuit of claim 16, wherein a collector of the first transistor of the pair of NPN-type transistors is coupled to the second input terminal, and wherein a collector of the second transistor of the pair of NPN-type transistors is coupled to the first input terminal.

19. The bridge rectifier circuit of claim 16, wherein a base of a first transistor of the pair of PNP-type transistors is coupled to the first input terminal, and wherein a base of a second transistor of the pair of PNP-type transistors is coupled to the second input terminal.

20. The bridge rectifier circuit of claim 16, wherein a collector of the first transistor of the pair of PNP-type transistors is coupled to the second input terminal, and wherein a collector of the second transistor of the pair of NPN-type transistors is coupled to the first input terminal.

21. The bridge rectifier circuit of claim 17, wherein a base of a first transistor of the pair of PNP-type transistors is coupled to the first input terminal and a base of a second transistor of the pair of PNP-type transistors is coupled to the second input terminal, and further comprising a resistor coupled between each of the respective bases of the NPN-type and PNP-type transistors and the respective input terminals.

22. The bridge rectifier circuit of claim 16, further comprising at least one light emitting diode coupled between the first and second output terminals.

23. The bridge rectifier circuit of claim 16, wherein the pair of NPN-type transistors are mounted in a first package and the pair of PNP-type transistors are mounted in a second package.

24. A bridge rectifier circuit comprising:
first and second input terminals;
first and second output terminals;
a first NPN-type transistor having the emitter coupled to the first output terminal, the collector coupled to the first input terminal, and the base coupled to the second input terminal;
a second NPN-type transistor having the emitter coupled to the first output terminal, the base coupled to the first input terminal, and the collector coupled to the second input terminal;
a first PNP-type transistor having the emitter coupled to the second output terminal, the collector coupled to the first input terminal, and the base coupled to the second input terminal; and
a second PNP-type transistor having the emitter coupled to the second output terminal, the base coupled to the first input terminal, and the emitter coupled to the second input terminal;
wherein the NPN-type transistors and PNP-type transistors are each configured to operate in reverse-active mode.
